(19) United States
(12) Patent Application Publication
(10) Pub. No.: US 2022/0219280 A1
(43) Pub. Date: Jul. 14, 2022

(54) OPTICAL CONNECTOR POLISHING PAD

(71) Applicant: NTT Advanced Technology Corporation, Kawasaki-shi, Kanagawa (JP)

(72) Inventors: Kenji Aoki, Kawasaki-shi (JP); Masaaki Konishi, Kawasaki-shi (JP); Naoki Sugita, Kawasaki-shi (JP)

(21) Appl. No.: 17/296,351

(22) PCT Filed: Aug. 20, 2020
(86) PCT No.: PCT/JP2020/031541

§ 371 Date: Dec. 29, 2021

(30) Foreign Application Priority Data
Sep. 3, 2019 (JP) 2019-160275

(51) Int. Cl. B24B 19/22

(52) U.S. Cl. CPC B24B 19/226

(57) ABSTRACT

An embodiment of the invention of this application provides a polishing pad that eliminates a gap between an optical connector and a polishing film during polishing. A polishing pad of the embodiment is used by being placed between a polishing platen and a polishing sheet in a case of performing spherical polishing of an end surface of an optical connector including an optical fiber and a ferrule. The optical connector polishing pad of the embodiment has rebound resilience higher than 20%. The optical connector polishing pad of the embodiment can be formed from a urethane-based material.

### TECHNICAL FIELD

This application relates to polishing of an end surface of an optical connector, or more specifically, to an optical connector polishing pad used in a case of performing spherical polishing of an end surface of an optical connector including an optical fiber and a ferrule.

### BACKGROUND ART

There has heretofore been known an optical connector polishing method of performing spherical polishing of an end surface of an optical connector including an optical fiber and a ferrule by bringing a polishing sheet (which will also be referred to as a “polishing film” in this specification) placed on a polishing platen via an elastic body (which will also be referred to as an “optical connector polishing pad” or more simply as a “polishing pad” in this specification) on the polishing platen into contact with the end surface of the optical connector and slidably moving and rotating the end surface relative to the polishing sheet in this state (see PTL 1 and NPL 1, for example).

Polishing rubber made of nitrile-based rubber has heretofore been used as the polishing pad.

An outline of optical connector polishing by using the conventional polishing rubber will be described with reference to FIG. 1. FIG. 1 illustrates cross-sections of an optical connector and the like during polishing. An optical connector 100 including an optical fiber 101 and a ferrule 102, a polishing film 200, and a polishing pad 300 which is polishing rubber are illustrated in FIG. 1. The polishing pad 300 is placed on a principal surface (an X-Y plane) of a polishing platen (not shown).

A polishing machine applies a polishing pressure from above the optical connector 100 in an end surface direction (a Z-axis direction), and causes the polishing film 200 and the optical connector 100 to slidably move and rotate relative to each other while maintaining a state of bringing an end surface of the optical connector 100 into contact with the polishing film 200. FIG. 1 illustrates a state of conducting a polishing movement of the polishing film 200 in a rightward direction (an X-axis direction) relative to the optical connector 100 fixed to the polishing machine. In FIG. 1, assuming that the polishing film 200 is at rest, the optical connector 100 slidably moves on the polishing film 200 in a leftward direction while using a left end of the end surface as a front end.

### CITATION LIST

### Patent Literature

PTL 1: Japanese Patent Laid-Open No. 2007-185754

### Non Patent Literature

NPL 1: “Optical Connector Polishers ATP-3200, ATP-3000”, NTT Advanced Technology Corporation, [online] [retrieved on Aug. 19, 2019], retrieved from the Internet <URL: https://keytech.ntt-at.co.jp/optic1/prd_0046.html>

### SUMMARY OF INVENTION

The polishing pressure in the optical connector polishing has been increasing in recent years to deal with rise of requirements involving flaws and taints on the end surface of the optical connector as well as an optical return loss thereof. In the meantime, the polishing pressure has been increased several times as high as before at sites of optical connector polishing for the reason of reduction in process time and so forth.

However, the conventional polishing rubber does not have sufficient restoring force (rebound resilience) against a high polishing pressure. In a case where the restoring force of the polishing rubber runs short as shown in FIG. 1, a gap is formed between the end surface of the optical connector 100 and the polishing film 200. FIG. 1 shows a state where part of the end surface (nearly a half of the surface including a left end of the end surface) of the optical connector 100 is in close contact with the polishing film 200, which is a state where the remaining portion of the end surface (nearly another half of the surface including a right end of the end surface) of the optical connector 100 is not in contact with the polishing film 200. Particularly, under the circumstances of overcrowded implementation (an increase in the number of LC connectors to be simultaneously polished from 18 terminals to 50 terminals, for example) and an increase in pressure associated therewith (such as a change of the polishing pressure from 100 gf to 500 gf) in recent years, a polishing trajectory formed by passage of a certain connector is traced by the next connector before the recessed polishing trajectory returns to a flat surface.

The polishing film 200 cannot exert a prescribed performance in this state. To be more precise, this state causes extended polishing time. Otherwise, this state causes development of flaws on the end surface of the optical fiber 101 due to dust caught in the gap formed between the end surface of the optical connector 100 and the polishing film 200, or causes a dent of the optical fiber 101 (fiber draw-in caused by drawing the optical fiber 101 in from the end surface of the optical connector 100).

An object of an embodiment of the invention of this application made in view of the above-mentioned problem is to provide a polishing pad that eliminates a gap between an optical connector and a polishing film during polishing.

To attain the object, an optical connector polishing pad according to an embodiment of the invention of this application is an optical connector polishing pad used by being placed between a polishing platen and a polishing sheet in a case of performing spherical polishing of an end surface of an optical connector including an optical fiber and a ferrule, which has rebound resilience higher than 20%.

As described above, the optical connector polishing pad according to an embodiment of the invention of this application can eliminate a gap between an optical connector and a polishing film during polishing. Moreover, it is possible to cause the polishing film to exert an intended performance (a polishing amount per hour). In addition, it is possible to reduce the occurrence of flaws and dents on an end surface of an optical fiber which are likely to be developed during the polishing.

### BRIEF DESCRIPTION OF DRAWINGS

FIG. 1 is a diagram for explaining an outline of optical connector polishing using conventional polishing rubber.

FIG. 2 is a diagram for explaining an outline of optical connector polishing using a polishing pad according to an embodiment of the invention of this application.

FIG. 3 is a table showing measurement values of a polishing pad according to Example 1 of the invention of this application and measurement values of a polishing pad of Comparative Example 1.

FIG. 4 is a graph showing the measurement values of the polishing pad according to Example 1 of the invention of this application and the measurement values of the polishing pad of Comparative Example 1.

FIG. 5 is a table showing measurement values of a polishing pad according to Example 2 of the invention of this application and measurement values of a polishing pad of Comparative Example 1.

FIG. 6 is a graph showing the measurement values of the polishing pad according to Example 2 of the invention of this application and the measurement values of the polishing pad of Comparative Example 1.

### DESCRIPTION OF EMBODIMENTS

An embodiment of the invention of this application will be described below in detail with reference to the drawings. The same reference signs in the drawings represent the same elements and repeated explanations thereof may be omitted as appropriate. Numerical values and materials cited in the following description do not intend to limit the scope of the invention of this application but intend to demonstrate examples thereof. Needless to say, the invention of this application can be embodied not only in accordance with the numerical values and the materials in the following description but also in accordance with other numerical values and other materials without departing from the gist of the invention of this application.

An optical connector polishing pad according to an embodiment of the invention of this application is characterized in that its rebound resilience is higher than 20%. Such an optical connector polishing pad can be realized by using a urethane-based material having higher rebound resilience (restoring force) than that of conventional nitrile-based rubber, for example. According to the optical connector polishing pad of the embodiment of the invention of this application, it is possible to eliminate a gap between an optical connector and a polishing film during polishing by using the pad having the rebound resilience larger (which is higher than 20%) than rebound resilience of a conventional polishing rubber pad.

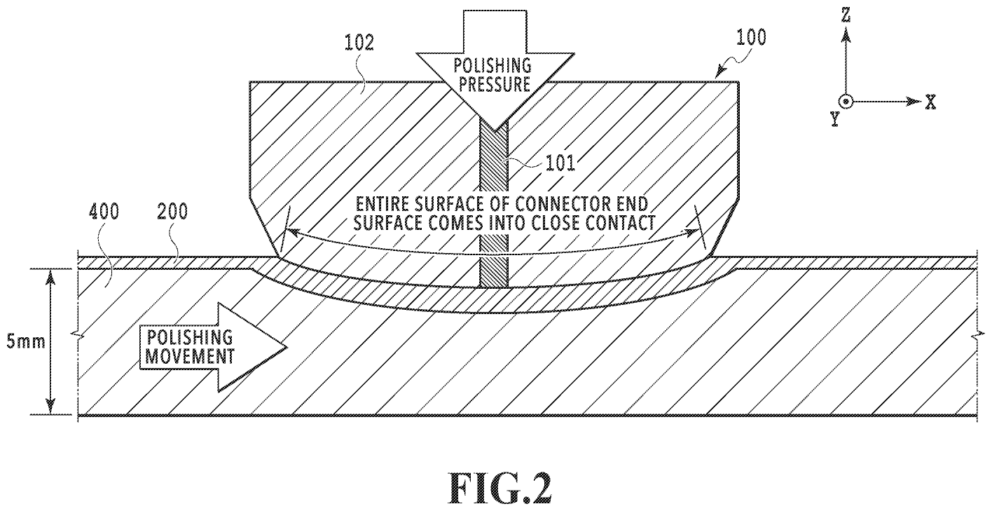

An outline of optical connector polishing by using the polishing pad according to this embodiment will be described with reference to FIG. 2. FIG. 2 shows cross-sections of optical connectors and the like during polishing. An optical connector 100 including an optical fiber 101 and a ferrule 102, a polishing film 200, and a polishing pad 400 according to this embodiment are illustrated in FIG. 2. The polishing pad 400 is placed on a principal surface (an X-Y plane) of a polishing platen (not shown). The polishing pad 400 is a plate-like pad having a thickness (in a Z-axis direction) of 5 mm, but is not limited only to the foregoing. A shape in plan view (a shape of the X-Y plane) may be formed into an arbitrary shape such as a rectangular shape and a circular shape in conformity to specifications of a polishing machine.

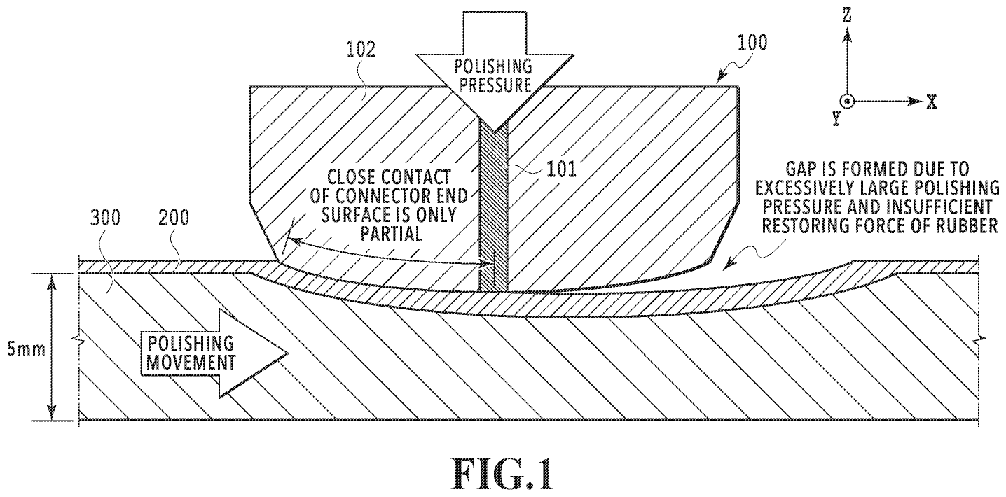

As with FIG. 1, FIG. 2 illustrates a state of conducting a polishing movement of the polishing film 200 in a rightward direction (an X-axis direction) relative to the optical connector 100 fixed to the polishing machine.

The polishing pad 400 of this embodiment has sufficient rebound resilience (restoring force) against a high polishing pressure. Accordingly, while the polishing machine causes the polishing film 200 and the optical connector 100 to slidably move and rotate relative to each other as shown in FIG. 2, an entire surface of the optical connector 100 is in a state of close contact with the polishing film 200 without forming a gap between an end surface of the optical connector 100 and the polishing film 200. Even under the circumstances of overcrowded implementation and an increase in pressure associated therewith as mentioned above, a polishing trajectory formed by passage of a certain connector returns to a flat surface from a recessed state before the polishing trajectory is traced by the next connector. In this state, the polishing film 200 can exert a prescribed performance so that polishing time can be shortened. Meanwhile, no gap is formed between the end surface of the optical connector 100 and the polishing film 200, which would catch dust to cause the occurrence of flaws and dents on an end surface of the optical fiber 101.

Examples of the polishing pad of this embodiment will be described below together with comparative examples. In the optical connector polishing, different polishing pads having Hs hardness (JIS K6400-3: 2011) of 65, 70, 75, and 80 are used in order to form a curvature radius of an end surface of each optical connector within a range of values defined in the standards. A polishing pad having lower Hs hardness is used for polishing a thicker optical connector (which has a larger diameter ϕ) while a polishing pad having higher Hs hardness is used for polishing a thinner optical connector (which has a smaller diameter ϕ).

Two examples to be described below will be explained by comparing a polishing pad (Example 1) having the Hs hardness of 80 (the highest Hs hardness) and a polishing pad (Example 2) having the Hs hardness of 70 (mediate Hs hardness), each being rubber made of a urethane-based material, with a conventional polishing rubber pad (Comparative Example 1) having the Hs hardness of 80 and a conventional polishing pad (Comparative Example 2) having the Hs hardness of 70, each being rubber made of a nitrile-based rubber material.

A height of the optical fiber at the end surface of the optical connector was measured (while defining a value of the height of the optical fiber (Fiber Height) in a case where the end surface of the connector coincides with the end surface of the optical fiber as 0 and expressing the value of the height of the optical fiber with a negative value in a case where the optical fiber is drawn in) as a benchmark for comparison. Meanwhile, an optical return loss of the optical fiber was measured as another benchmark for comparison. In addition, the number of times of the polishing film used (the life of the polishing film) was measured as still another benchmark for comparison.

### EXAMPLE 1

The polishing pad of Example 1 is a rubber pad made of the urethane-based material and has the Hs hardness of Hs 80±2 (multiple polishing pads were used during a period until one polishing film was determined to have reached the end of its life).

An average of the rebound resilience (restoring force) of the polishing pad of this example is 50% (JIS K6400-3: 2011), which is 2.5 times as high as the rebound resilience of the polishing rubber pad of Comparative Example 1 made of the nitrile-based rubber material.

The polishing rubber pad of Comparative Example 1 is the polishing rubber pad made of the nitrile-based rubber (a conventional product) and has the Hs hardness of Hs 80±3 (multiple polishing pads were used during a period until one polishing film was determined to have reached the end of its life).

An average value of the rebound resilience (restoring force) of Comparative Example 1 is 20% (JIS K6400-3: 2011).

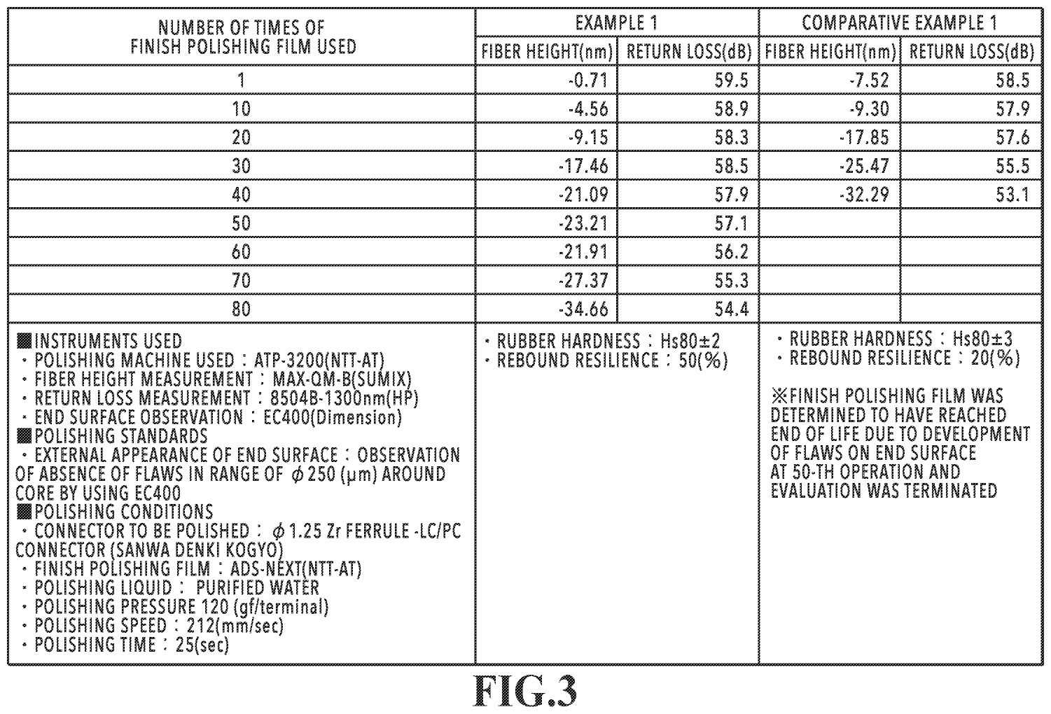

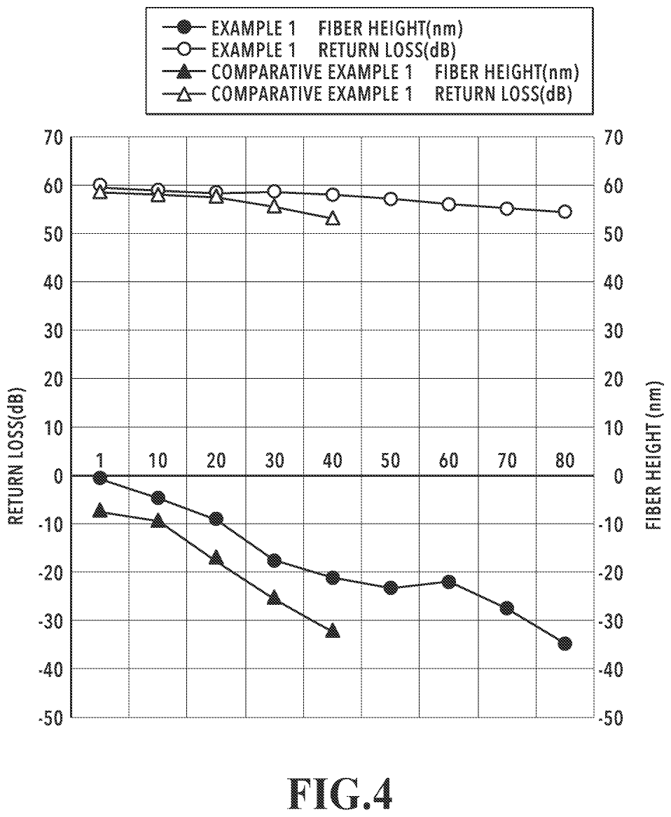

FIGS. 3 and 4 show a result of comparison between the properties of the polishing pad of Example 1 and the polishing rubber pad of Comparative Example 1.

As for the measurement, the optical connector was polished multiple times by using the single polishing film and the height of the optical fiber and the optical return loss of the optical fiber were measured after 1-st, 10-th, 20-th, 30-th, 40-th, . . . 70-th, and 80-th polishing operations. The polishing film was subjected to cleaning every time after the polishing. The life of the polishing film was determined by observing the optical fiber to check whether or not any flaws are developed on an end surface of a core of the optical fiber before the measurement. The measurement of the height of the optical fiber and the optical return loss of the optical fiber were repeated until the polishing film was determined to have reached the end of its life. Instruments used, polishing standards, and polishing conditions are the same regarding both of the polishing pad of Example 1 and the polishing rubber pad of Comparative Example 1 (see FIG. 3). Note that although the same polishing time (25 sec) was also applied to both of Example 1 and Comparative Example 1 so as to adopt the same polishing conditions, the use of the polishing pad of Example 1 enables completion of the polishing in a shorter time than that in the case of using the polishing rubber pad of Comparative Example 1.

As shown in FIG. 3, regarding the polishing rubber pad of Comparative Example 1, flaws were developed on the end surface of the core of the optical fiber at the 50-th polishing operation. Accordingly, this was determined as the end of the life of the polishing film and the measurement and evaluation were terminated. On the other hand, according to the polishing pad of this example, no flaws were developed on the end surface of the core of the optical fiber even after 80 times of the polishing operations and the number of times of the polishing film used reached nearly twice as many Hence, it is apparent that the life of the polishing film of this example becomes longer than the case of Comparative Example 1.

Moreover, as it is understood from FIGS. 3 and 4, the height of the optical fiber is larger (the drawn-in amount of the fiber is less) in the case of using the polishing pad of this example than the case of using the polishing rubber pad of Comparative Example 1. Meanwhile, the optical return loss is smaller (the amount of reflection on the end surface is less) in the case of using the polishing pad of this example than the case of using the polishing rubber pad of Comparative Example 1.

### EXAMPLE 2

The polishing pad of Example 2 is a rubber pad made of the urethane-based material and has the Hs hardness of Hs 70±2 (multiple polishing pads were used during a period until one polishing film was determined to have reached the end of its life).

An average of the rebound resilience (restoring force) of the polishing pad of this example is 46% (JIS K6400-3: 2011), which is about 2.88 times as high as the rebound resilience of the polishing rubber pad of Comparative Example 2 made of the nitrile-based rubber material.

The polishing rubber pad of Comparative Example 2 is the polishing rubber pad made of the nitrile-based rubber (a conventional product) and has the Hs hardness of Hs 70±2 (multiple polishing pads were used during a period until one polishing film was determined to have reached the end of its life).

An average value of the rebound resilience (restoring force) of Comparative Example 2 is 16% (JIS K6400-3: 2011).

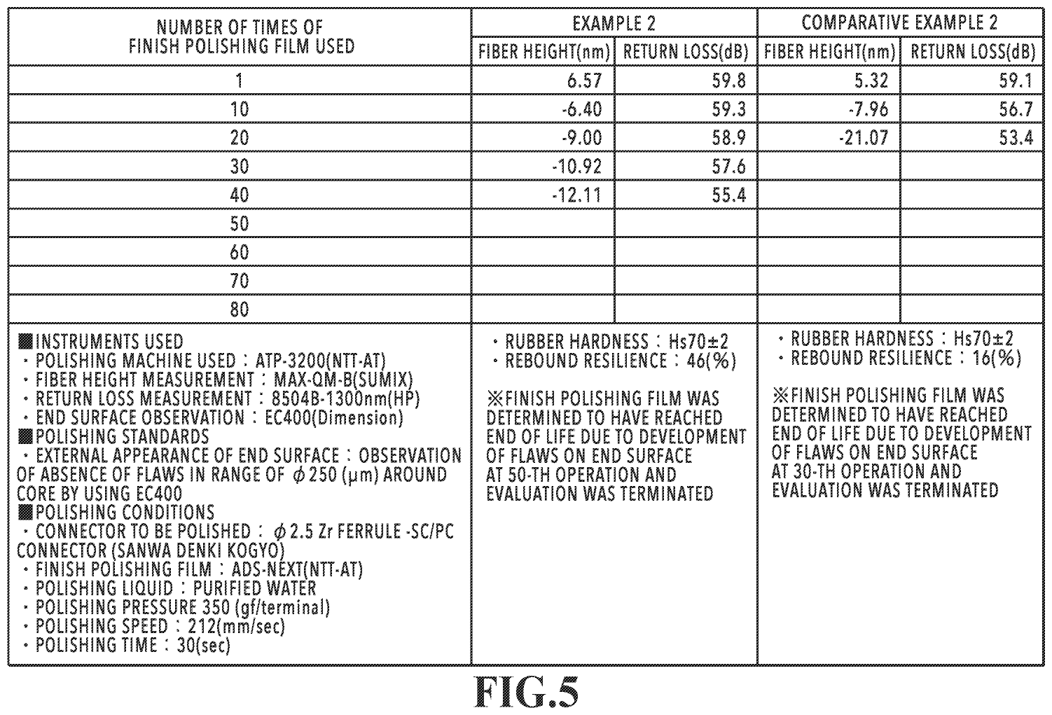

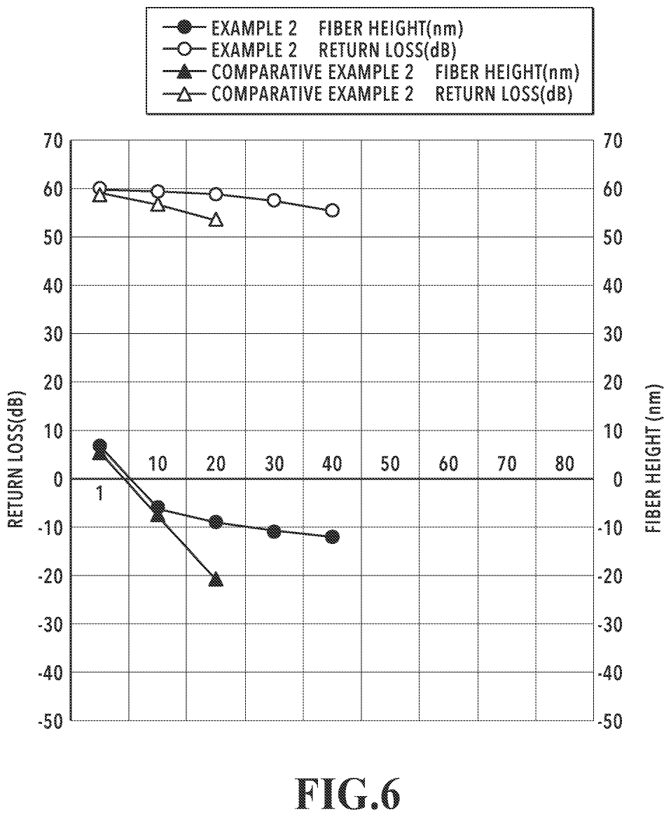

FIGS. 5 and 6 show a result of comparison between the properties of the polishing pad of Example 2 and the polishing rubber pad of Comparative Example 2.

The measurement was conducted in the same manner as those described in conjunction with Example 1. Note that although the same polishing time (30 sec) was applied to both of Example 2 and Comparative Example 2 so as to adopt the same polishing conditions in these examples as well, the use of the polishing pad of Example 2 enables completion of the polishing in a shorter time than that in the case of using the polishing rubber pad of Comparative Example 2.

As shown in FIG. 5, regarding the polishing rubber pad of Comparative Example 2, flaws were developed on the end surface of the core of the optical fiber at the 30-th polishing operation. Accordingly, this was determined as the end of the life of the polishing film and the measurement and evaluation were terminated. On the other hand, according to the polishing pad of this example, flaws were developed on the end surface of the core of the optical fiber at the 50-th polishing operation. Accordingly, this was determined as the end of the life of the polishing film and the measurement and evaluation were terminated. In this example, the number of times of the polishing film used reached nearly about twice as many Hence, it is apparent that the life of the polishing film of this example becomes longer than the case of Comparative Example 2.

Moreover, as it is understood from FIGS. 5 and 6, the height of the optical fiber is larger (the drawn-in amount of the fiber is less) in the case of using the polishing pad of this example than the case of using the polishing rubber pad of Comparative Example 2. Meanwhile, the optical return loss is smaller (the amount of reflection on the end surface is less) in the case of using the polishing pad of this example than the case of using the polishing rubber pad of Comparative Example 2.

Although details are omitted, a polishing pad having the Hs hardness of Hs 65 (the recount resilience of 43%) was formed by using a rubber pad made of a urethane-based material, and was subjected to the measurement and evaluation similar to those described above. A similar result was successfully obtained.

As described above, according to the optical connector polishing pad according to an embodiment of the invention of this application, it is possible to eliminate the gap between the optical connector and the polishing film during polishing by using the pad having the rebound resilience higher than (which is higher than 20%) the rebound resilience of the conventional polishing rubber pad made of a nitrile-based rubber material as the optical connector polishing pad. Moreover, it is possible to cause the polishing film to exert an intended performance (a polishing amount per hour), thereby reducing the number of times of the polishing film used and to shorten the polishing time. In addition, it is possible to reduce the occurrence of flaws and dents on the end surface of the optical fiber which are likely to be developed during the polishing.

1. An optical connector polishing pad used by being placed between a polishing platen and a polishing sheet in a case of performing spherical polishing of an end surface of an optical connector including an optical fiber and a ferrule, wherein rebound resilience of the optical connector polishing pad is higher than 20%.

2. The optical connector polishing pad according to claim 1, wherein a material of the optical connector polishing pad is urethane-based.
